(19) United States
(12) Patent Application Publication
(10) Pub. No.: US 2014/0295260 A1
(43) Pub. Date: Oct. 2, 2014

(54) METHOD FOR PRODUCING SULFIDE SOLID ELECTROLYTE

(71) Applicants: Koichi Sugiura, Susono-shi (JP); Miwako Ohashi, Mishima-shi (JP)

(72) Inventors: Koichi Sugiura, Susono-shi (JP); Miwako Ohashi, Mishima-shi (JP)

(73) Assignee: TOYOTA JIDOSHA KABUSHIKI KAISHA, Toyota-shi (JP)

(21) Appl. No.: 14/355,985

(22) PCT Filed: Nov. 17, 2011
(86) PCT No.: PCT/JP2011/076530

§ 371 Date: May 2, 2014

(51) Int. Cl. H01M 10/0562; H01M 10/0525

(52) U.S. Cl. CPC H01M 10/0562; H01M 10/0525
USPC 429/189

(57) ABSTRACT

An object of the present invention is to provide a method for producing a sulfide solid electrolyte with which productivity of a sulfide solid electrolyte having a small average particle diameter can be improved. The present invention is the method for producing a sulfide solid electrolyte including a mixing step of mixing a solvent and one or more selected from a group consisting of a sulfide solid electrolyte and a raw material of the sulfide solid electrolyte, thereby obtaining a mixture and a grinding step of mechanically grinding the sulfide solid electrolyte using both a first grinding medium having a diameter of less than 1 mm and a second grinding medium having a diameter of no less than 1 mm at the same time.

### TECHNICAL FIELD

The present invention relates to a method for producing a sulfide solid electrolyte.

### BACKGROUND ART

A lithium-ion secondary battery has characteristics that it has a higher energy density and is operable at a higher voltage compared to other secondary batteries. Therefore, it is used for information equipments such as cellular phones, as a secondary battery which can be easily reduced in size and weight. And, in recent years, there has also been an increasing demand of the lithium-ion secondary battery to be used as a power source for large-scale apparatuses such as electric vehicles and hybrid vehicles.

A lithium-ion secondary battery includes: a cathode layer; an anode layer; and an electrolyte layer disposed between them. An electrolyte to be employed in the electrolyte layer is, for example, a non-aqueous liquid or a solid. When the liquid is used as the electrolyte (hereinafter, the liquid being referred to as “electrolytic solution”), it permeates into the cathode layer and the anode layer easily. Therefore, an interface can be formed easily between the electrolytic solution and active materials contained in the cathode layer and the anode layer respectively, and the battery performance can be easily improved. However, since commonly used electrolytic solutions are flammable, it is necessary to mount a system to ensure safety. On the other hand, since electrolytes in solid form (hereinafter referred to as “solid electrolyte”) are nonflammable, when the solid electrolyte is applied, the above system can be simplified. As such, development of lithium-ion secondary batteries having a layer containing a solid electrolyte has been progressing. (hereinafter, the layer being referred to as “solid electrolyte layer” and the battery being referred to as “solid battery”).

As a technique related to such a solid battery, for example, Patent Document 1 discloses a technique, in producing a sulfide solid electrolyte using a ball mill, to use a group of balls comprising 2 or more kinds of balls whose diameters are different to each other. In the paragraph 0018 of the specification of Patent Document 1 discloses that, the 2 or more kinds of balls each preferably has a ball diameter within a range of 5 to 40 mm φ, and in a case where the ball diameter is less than 5 mm φ, since energy per ball is small, there is a risk that a solid electrolyte having a high conductivity is not to be made. Also, Patent Document 2 discloses a manufacturing method of a sulfide-based solid electrolyte microparticle, the method comprising multistage grinding of a sulfide-based solid electrolyte coarse particle into the sulfide-based solid electrolyte microparticle having an average particle diameter of 0.1 to 10 μm. The paragraph 0022 of the specification of Patent Document 2 describes that in a case where a grinding machine using a ball as a grinding medium is employed, it is preferable to carry out the multistage grinding firstly using a comparatively large ball (no less than 1 mm φ, preferably 1 to 50 mm φ), followed by using a comparatively small ball (0.1 to 0.6 mm φ).

### CITATION LIST

### Patent Literatures

Patent Document 1: Japanese Patent Application Laid-Open No. 2010-90003
Patent Document 2: Japanese Patent Application Laid-Open No. 2008-4459

### SUMMARY OF THE INVENTION

### Problems to be Solved by the Invention

In the technique disclosed in Patent Document 1, since a large ball is used, it is difficult to obtain a sulfide solid electrolyte having a small average particle diameter. It is effective to use a grinding medium having small diameter to obtain a sulfide solid electrolyte having a small particle diameter. However, grinding energy to grind a coarse particle is different from grinding energy to obtain a microparticle. Therefore, it is difficult to obtain a sulfide solid electrolyte having a small average particle diameter from a sulfide solid electrolyte having a large initial particle diameter by using only a grinding medium having a small diameter. In order to obtain a sulfide solid electrolyte having a small diameter by using a grinding medium having a small diameter, the particle diameter of the sulfide solid electrolyte to be grinded needs to be in a predetermined range. Here, as a control factor of grinding energy, material, diameter, and peripheral speed of the grinding medium can be considered. In a case where the grinding energy is controlled by the material of the grinding medium, the grinding medium having same diameters to each other is used, whereby microparticulation is difficult to be promoted. Also, trying to control the grinding energy by the peripheral speed of the grinding medium, if more energy than needed is given in grinding, the solid electrolyte particle is rapidly granulated to become secondary particle thereby generating a grain boundary resistivity, and because of this an ion conductivity of the sulfide solid electrolyte is tend to be degraded. For this reason, in order to give a plurality of grinding energies, it is effective to control the diameter of the grinding medium. From this viewpoint, a method including a multistage grinding as described in Patent Document 2 has been suggested until now. According to a technique to carry out the multistage grinding, it is considered that a sulfide solid electrolyte having a small particle diameter can be obtained. However, if the sulfide solid electrolyte is grinded to be a microparticle by the multistage grinding, the number of the steps of producing a sulfide solid electrolyte having a small average particle diameter is increased, whereby productivity tends to be degraded. Therefore, even though the techniques disclosed in Patent Documents 1 and 2 are combined, it is difficult to improve productivity of a sulfide solid electrolyte having a small average particle diameter.

Accordingly, an object of the present invention is to provide a method for producing a sulfide solid electrolyte which can improve productivity of a sulfide solid electrolyte having a small particle diameter.

### Means for Solving the Problems

The inventors of the present invention has been found out, from an intensive study, that a sulfide solid electrolyte having a small average particle diameter can be produced with a good productivity by: mixing a solvent and one or more selected from the group consisting of a sulfide solid electrolyte and a raw material of the sulfide solid electrolyte; and mechanically grinding the mixture using a grinding medium (ball, bead) having a diameter of less than 1 mm and a grinding medium (ball, bead) having a diameter of no less than 1 mm at the same time. The present invention has been made based on the above findings.

In order to solve the above problems, the present invention takes the following means. Namely, the present invention is a method for producing a sulfide solid electrolyte comprising: a mixing step of mixing a solvent and one or more selected from a group consisting of a sulfide solid electrolyte and a raw material of the sulfide solid electrolyte, thereby obtaining a mixture; and a grinding step of mechanically grinding the sulfide solid electrolyte using both a first grinding medium having a diameter of less than 1 mm and a second grinding medium having a diameter of no less than 1 mm at the same time.

Here, the “grinding medium” refers to a medium such as a ball used for a planetary ball mill, a butch type ball mill and the like, and a bead used for a circulation type bead mill and the like. Also, in a case where the mixture is obtained by a raw material of a sulfide solid electrolyte, without using a sulfide solid electrolyte in the mixing step, the “sulfide solid electrolyte” to be grinded in the grinding step refers to, for example, a sulfide solid electrolyte made by means of an apparatus such as a planetary ball mill, prepared by: putting the mixture together with the first grinding medium and the second grinding medium in such an apparatus; thereafter using the raw material of the sulfide solid electrolyte contained in the mixture to synthesis the sulfide solid electrolyte.

In the present invention, undergoing the grinding step in which the first grinding medium and the second grinding medium are used at the same time to mechanically grind the mixture, the sulfide solid electrolyte is produced. In the grinding step, the sulfide solid electrolyte having a large initial particle diameter is grinded by the second grinding medium, after that, the grinded sulfide solid electrolyte is further grinded by the first grinding medium. By using the first grinding medium and the second grinding medium, it is possible to obtain the sulfide solid electrolyte having a small average particle diameter, and by using the first grinding medium and the second grinding medium at the same time, it is possible to improve productivity of the sulfide solid electrolyte.

Also, in the present invention described above, it is preferable that an ether compound is mixed to be grinded in the grinding step. Since such a configuration makes it possible to prevent anchoring to the first grinding medium and the second grinding medium and reaggregation of the sulfide solid electrolyte, productivity of the sulfide solid electrolyte having a small average particle diameter is likely to be improved. Here, in the present invention, the “ether compound” includes dimethyl ether, diethyl ether, dipropyl ether, dibutyl ether, cyclopentylmethyl ether, anisole and the like.

### Effect of the Invention

According to the present invention, it is possible to provide a method for producing a sulfide solid electrolyte with which productivity of a sulfide sold electrolyte having a small average particle diameter can be improved.

### BRIEF DESCRIPTION OF DRAWINGS

FIG. 1 is a flowchart describing a method for producing a sulfide solid electrolyte of the present invention;

FIG. 2 is a view describing the method for producing a sulfide solid electrolyte of the present invention;

FIG. 3 is a graph showing a relationship between lithium ion conductivity and average particle diameter of sulfide solid electrolytes according to the Examples and Comparative Examples;

FIG. 4 is a photograph of a sulfide solid electrolyte of Example 1;

FIG. 5 is a photograph of a sulfide solid electrolyte of Example 2;

FIG. 6 is a photograph of a sulfide solid electrolyte of Example 3;

FIG. 7 is a photograph of a sulfide solid electrolyte of Example 4;

FIG. 8 is a photograph of a sulfide solid electrolyte of Comparative Example 1;

FIG. 9 is a photograph of a sulfide solid electrolyte of Comparative Example 2;

FIG. 10 is a photograph of a sulfide solid electrolyte of Comparative Example 3;

FIG. 11 is a photograph of the sulfide solid electrolyte of Comparative Example 3;

FIG. 12 is a photograph of the sulfide solid electrolyte of Comparative Example 4;

FIG. 13 is a photograph of the sulfide solid electrolyte of Comparative Example 5.

### MODES FOR CARRYING OUT THE INVENTION

Hereinafter, the present invention will be described with reference to the drawings. In the following drawings, repeated reference numerals are partly omitted. It should be noted that the embodiments shown below are examples of the present invention, and the present invention is not limited to the embodiments shown below.

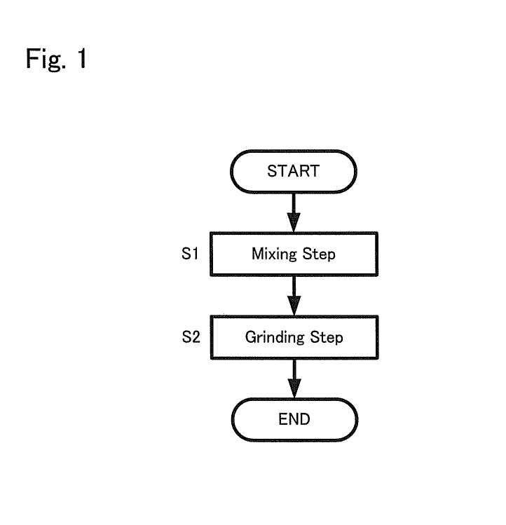

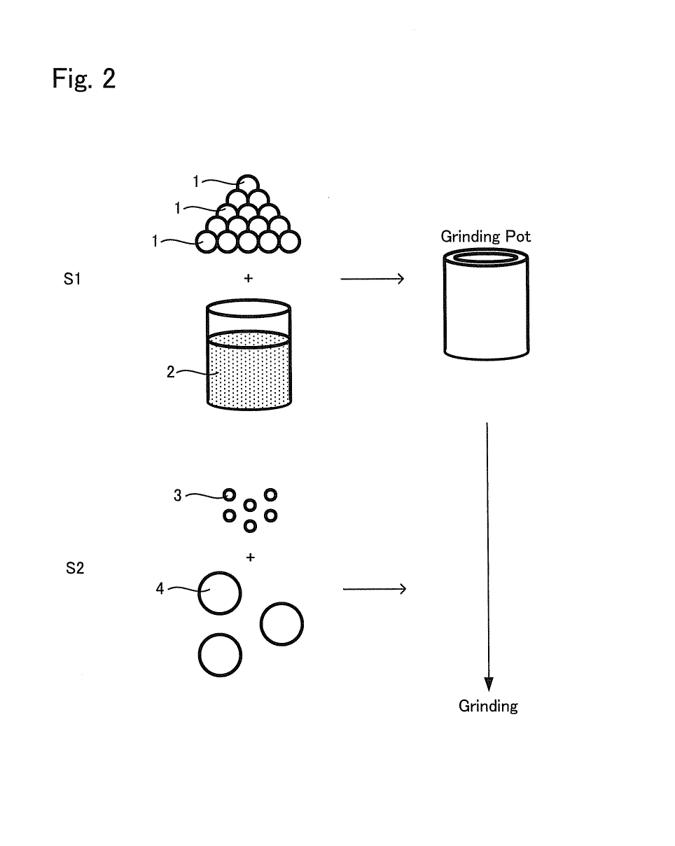

FIG. 1 is a view describing a method for producing a sulfide solid electrolyte of the present invention (hereinafter, sometimes referred to as “producing method of the present invention”). FIG. 2 is a view describing the producing method of the present invention using the sulfide solid electrolyte 1, 1, . . . in the mixing step. As shown in FIGS. 1 and 2, the producing method of the present invention includes the mixing step (S1) and the grinding step (S2).

The mixing step (hereinafter sometimes referred to as “S1”) is a step of mixing a solvent and one or more selected from a group consisting of a sulfide solid electrolyte and a raw material of the sulfide solid electrolyte, thereby obtaining a mixture. S1 can be configured such that the sulfide solid electrolyte 1, 1, . . . and a solvent 2 are mixed to obtain the mixture as shown in FIG. 2, can be configured such that the sulfide solid electrolyte, the raw material of the sulfide solid electrolyte and the solvent are mixed to obtain the mixture or can be configured such that the raw material of the sulfide solid electrolyte and the solvent are mixed to obtain the mixture.

In a case where the produced sulfide solid electrolyte 1, 1, . . . is employed in S1, producing method of the sulfide solid electrolyte 1, 1, . . . is not particularly limited. The sulfide solid electrolyte 1, 1, . . . is, for example, can be produced by a method described in Japanese Patent Application No. 2010-189965 and the like. Also, in the case where the raw material of the sulfide solid electrolyte is employed, in S1, S1 can be a step to obtain the mixture by the method described in Japanese Patent Application No. 2010-186682 and the like. Also, in a case where the sulfide solid electrolyte and the raw material of the sulfide solid electrolyte are employed in S1, the mixture can be obtained in the same manner as in the case where the raw material of the sulfide solid electrolyte is employed except that the produced sulfide solid electrolyte is also mixed.

The grinding step (hereinafter sometimes referred to as “S2”) is a step of mechanically grinding the sulfide solid electrolyte using both of a first grinding medium 3, 3, . . . having a diameter of less than 1 mm and a second grinding medium 4, 4, . . . having a diameter of no less than 1 mm at the same time. In the case where the mixture is obtained by mixing the sulfide solid electrolyte 1, 1, . . . and the solvent 2 without using the raw material of the sulfide solid electrolyte in S1 described above, the sulfide solid electrolyte mechanically to be grinded in S2 is the sulfide solid electrolyte 1, 1, . . . that was contained in the mixture. Also, in the case where the mixture is obtained by mixing the sulfide solid electrolyte, the raw material of the sulfide solid electrolyte and the solvent, the sulfide solid electrolyte mechanically to be grinded in S2 is the sulfide solid electrolyte that was contained in the mixture and the sulfide solid electrolyte that was produced in S2. Also, in a case where the mixture is obtained by mixing the raw material of the sulfide solid electrolyte and the solvent without using the sulfide solid electrolyte, the sulfide solid electrolyte mechanically to be grinded in S2 is the sulfide solid electrolyte that was produced in S2.

In S2 in which the first grinding medium 3, 3, . . . and the second grinding medium 4, 4, . . . are employed at the same time, the sulfide solid electrolyte having a large initial particle diameter is grinded mechanically by the second grinding medium 4, 4, . . . and after that, the grinded sulfide solid electrolyte is further grinded mechanically by the first grinding medium 3, 3, . . . . By mechanically grinding the sulfide solid electrolyte using the first grinding medium 3, 3, . . . and the second grinding medium 4, 4, . . . , it is possible to obtain the sulfide solid electrolyte having a small average particle diameter, and by using the first grinding medium 3, 3, . . . and the second grinding medium 4, 4, . . . at the same time, it is possible to improve productivity of the sulfide solid electrolyte having a small average particle diameter. Therefore, according to the producing method of the present invention in which a sulfide solid electrolyte is produced by undergoing S1 and S2, it is possible to improve productivity of the sulfide solid electrolyte having a small average particle diameter.

In the present invention, as the sulfide solid electrolyte that can be employed in the mixing step, Li₂S—SiS₂, LiI—Li₂S—SiS₂, LiI—Li₂S—P₂S₅, LiI—Li₂S—P₂O₅, LiI—Li₃PO₄—P₂S₅, Li₂S—P₂S₅, Li₃PS₄ and the like can be exemplified. In the present invention, a sulfide solid electrolyte in which a ratio of total of molecular weights of Li, P and S to molecular amount of the sulfide solid electrolyte is no less than 10% can be preferably used, and a sulfide solid electrolyte containing one or more elements selected from the group consisting of F, Cl, Br, and I can be preferably used.

Also, as the raw material of the sulfide solid electrolyte that can be used in the mixing step, a known material that can be used as a raw material of a sulfide solid electrolyte can be adequately used. As the raw material of the sulfide solid electrolyte, (i) Li₂S and SiS₂, (ii) LiI, Li₂S and SiS₂, (iii) LiI, Li₂S and P₂S₅, (iv) LiI, Li₂S and P₂O₅, (v) LiI, Li₃PO₄ and P₂S₅, (vi) Li₂S and P₂S₅, or mixture thereof and the like can be exemplified.

Also, the solvent that can be used in the mixture step is not particularly limited, and a solvent that does not react to sulfide can be preferably used. As the solvent, saturated hydrocarbon, aromatic compound such as benzene, toluene and xylene and the like can be exemplified.

Also, in the present invention, materials of the first grinding medium 3, 3, . . . and the second grinding medium 4, 4, . . . used in the grinding step are not particularly limited, and ceramics that are not contaminated by a metal can be preferably used. As the ceramics, zirconia, alumina, agate and the like can be preferably exemplified. Among these, zirconia and alumina that are difficult to be contaminated by a metal can be more preferably used.

Also, a diameter of the first grinding medium 3, 3, . . . to be used in the mixing step is not particularly limited as long as the diameter is less than 1 mm. The diameter of the first grinding medium 3, 3, . . . can be 0.1 mm to less than 1 mm for example. A diameter of the second grinding medium 4, 4, . . . to be used in the mixing step is not particularly limited as long as the diameter is no less than 1 mm. The diameter of the second grinding medium 4, 4, . . . can be 1 mm to 5 mm for example.

Also, in the mixing step, a method of mechanically grinding the sulfide solid electrolyte is not particularly limited as long as the mixing step is a step of mechanically grinding the sulfide solid electrolyte using the first grinding medium 3, 3, . . . and the second grinding medium 4, 4, . . . at the same time. As the method of grinding that can be employed in the present invention, a method using a planetary ball mill, a circulation type ball mill, a butch type ball mill or the like can be exemplified.

Also, in view of enabling preventing the sulfide solid electrolyte from anchoring to the first grinding medium 3, 3, . . . and the second grinding medium 4, 4 . . . reaggregation and the like, in the present invention, it is preferable that an ether compound is added when the sulfide solid electrolyte is mechanically grinded by the first grinding medium 3, 3, . . . and the second grinding medium 4, 4, . . . at the same time. As the ether compound that can be used in the present invention, dimethyl ether, diethyl ether, dipropyl ether, dibutyl ether, cyclopentylmethyl ether, anisole and the like can be exemplified. Among these, diethyl ether, dipropyl ether, and dibutyl ether each having a low boiling point (60° C. to 200° C.) and a low polarity can be preferably used.

Also, in the present invention, mixing ratio of the first grinding medium 3, 3, . . . and the second grinding medium 4, 4, . . . used in the mixing step is not particularly limited, however, in view of making a configuration by which the sulfide solid electrolyte having a small average particle diameter is easily obtained, it is preferable to make the number of the first grinding medium 3, 3, . . . to be used is larger than the number of the second grinding medium 4, 4, . . . .

Also, in the above description related to the present invention, a configuration having the mixing step in which the first grinding medium 3, 3, . . . and the second grinding medium 4, 4, . . . are used at the same time is exemplified, however, the number of kinds of the grinding media used at the same time in the mixing step of the present invention is not limited to two kinds. The mixing step according to the present invention can be a step of mechanically grinding the sulfide solid electrolyte in which one or more kinds of other grinding media are used in addition to the first grinding medium 3, 3, . . . having a diameter of less than 1 mm and the second grinding medium 4, 4, . . . having a diameter of no less than 1 mm at the same time.

Also, in the above description related to the present invention, a configuration in which the mixing step is followed by the grinding step, however, the present invention is not limited to this configuration. The present invention can be configured such that a sulfide solid electrolyte micro particle is produced by undergoing a step of mixing a solvent and one or more selected from a group consisting of a sulfide solid electrolyte and a raw material of the sulfide solid electrolyte and mechanically grinding the sulfide solid electrolyte using the first grinding medium and the second grinding medium at the same time.

The sulfide solid electrolyte produced by the producing method of the present invention can be employed for a solid electrolyte layer, a cathode, and an anode of a solid battery and the like.

### EXAMPLES

Hereinafter, the present invention will be further specifically described, with reference to Examples and Comparative Examples.

1. Production of Sulfide Solid Electrolyte

### <Mixing of Raw Material of Sulfide Solid Electrolyte>

Phosphorus pentasulfide (manufactured by Sigma-Aldrich Co. LLC.) and 70.0 g of lithium sulfide (manufactured by Nippon Chemical Industrial Co., LTD., purity of 99.9%) were premixed by means of an agate mortar. After that, the resulting mixture was further mixed by a dry mechanical milling with a condition of 300 rotations per minute for 20 hours, whereby a powder mix of a raw material of a sulfide solid electrolyte was obtained.

### <Grinding Step>

### Example 1

The powder mix of the raw material of the sulfide solid electrolyte described above in an amount of 1 g, 40 g of grinding medium (10 g of ZrO₂ balls each having a diameter of 1 mm and 30 g of ZrO₂ balls each having a diameter of 0.3 mm), 8 g of solvent (dehydrated heptane, manufactured by Kanto Chemical Co., INC.), and 1 g of additive agent (dibutyl ether) were put in a ZrO₂ pot of 45 ml. Thereafter, using a planetary ball mill (manufactured by Fritsch, P7), grinding treatment was carried out to them with a condition of 150 rotations per minute for 10 hours by means of mechanical milling method, whereby a sulfide solid electrolyte of the Example 1 was obtained.

### Example 2

A sulfide solid electrolyte of Example 2 was obtained with the same condition as in Example 1 described above except that the grinding treatment was carried out for 20 hours.

### Example 3

A sulfide solid electrolyte of Example 3 was obtained with the same condition as in Example 1 described above except that the number of rotation of the grinding treatment was changed to 200 rotations per minute.

### Example 4

A sulfide solid electrolyte of Example 4 was obtained with the same condition as in Example 2 described above except that 20 g of ZrO₂ balls each having a diameter of 1 mm and 20 g of ZrO₂ balls each having a diameter of 0.3 mm were used.

### Comparative Example 1

The powder mix of the raw material of the sulfide solid electrolyte described above in an amount of 1 g, 40 g of grinding medium (40 g of ZrO₂ balls each having a diameter of 1 mm), 8.9 g of solvent (dehydrated heptane, manufactured by Kanto Chemical Co., INC.) and 0.1 g of additive agent (dibuthyl ether) were put in a ZrO₂ pot of 45 ml. Thereafter, using a planetary ball mill (manufactured by Fritsch, P7), grinding treatment was carried out to them with a condition of 150 rotations per minute for 10 hours, whereby a sulfide solid electrolyte of Comparative Example 1 was obtained.

### Comparative Example 2

A sulfide solid electrolyte of Comparative Example 2 was obtained with the same condition as in Comparative Example 1 described above except that the number of rotation of the grinding treatment was changed to 100 rotations per minute.

### Comparative Example 3

The powder mix of raw material of the sulfide solid electrolyte described above in an amount of 1 g, 40 g of grinding medium (40 g of ZrO₂ balls each having a diameter of 0.3 mm), 8 g of solvent (dehydrated heptane, manufactured by Kanto Chemical Co. LTD.) and 1 g of additive agent (dibuthyl ether) were put in a ZrO₂ pot of 45 ml. Thereafter, using a planetary ball mill (manufactured by Fritsch, 97), a grinding treatment was carried out with a condition of 200 rotations per minute for 10 hours by mechanical milling method, whereby a sulfide solid electrolyte of Comparative Example 3 was obtained.

### Comparative Example 4

A sulfide solid electrolyte of Comparative Example 4 was obtained with the same condition as in Comparative Example 3 described above except that the number of rotations of the grinding treatment was changed to 300 rotations per minute.

### Comparative Example 5

A sulfide solid electrolyte of Comparative Example 5 was obtained with the same condition as in Comparative Example 3 except that the number of rotations of the grinding treatment was changed to 450 rotations per minute.

2. Lithium Ion Conductivity Measurement

The sulfide solid electrolytes of Examples 1 to 4 and Comparative Examples 1 to 5 obtained were each weighed in amount of 0.1 g. Then, each sulfide solid electrolyte was pressed by a pressure of 421.4 MPa, whereby 9 pellets were produced. After that, without exposing them in an atmosphere, using a constant-temperature zone to adjust a temperature to 25° C. and using Solartron 1260 manufactured by Toyo Corporation, lithium ion conductivity of each of the 9 pellets were measured by an alternating-current impedance method.

3. Particle Size Distribution Measurement

The sulfide solid electrolyte of Examples 1 to 4 and Comparative Examples of 1 to 5 obtained were each sampled in a small amount, and each particle size distribution was measured by a laser diffraction/scattering particle size distribution analyzer (manufactured by Nikkiso Co., LTD., Microtrac MT3300EXII).

4. Results

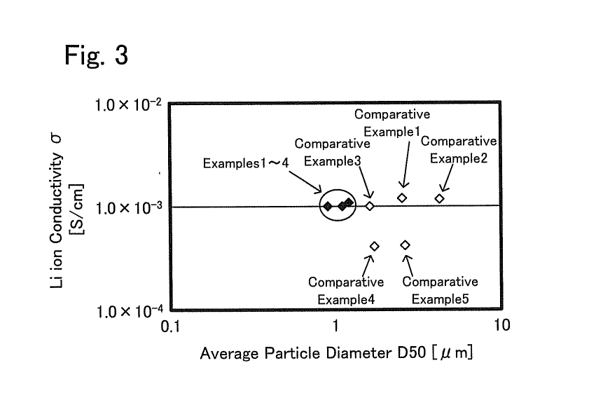

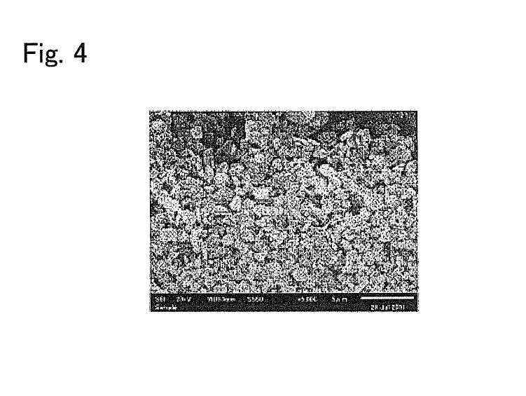

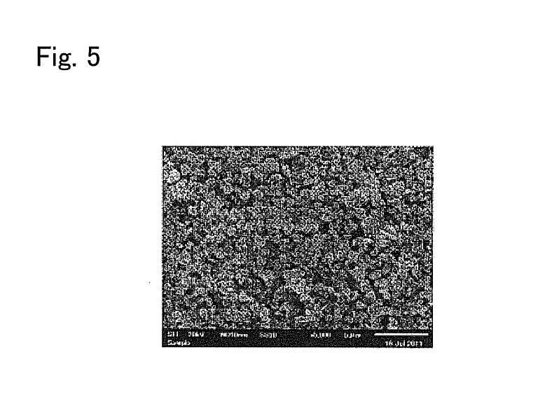

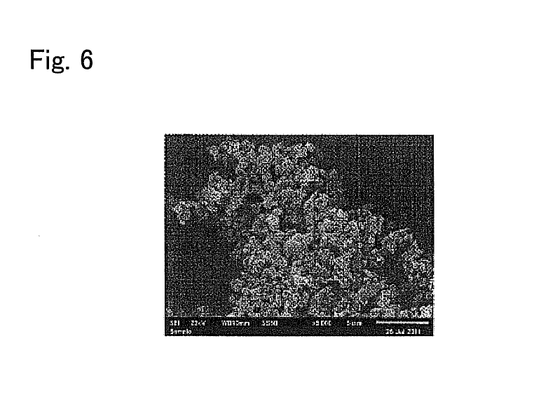

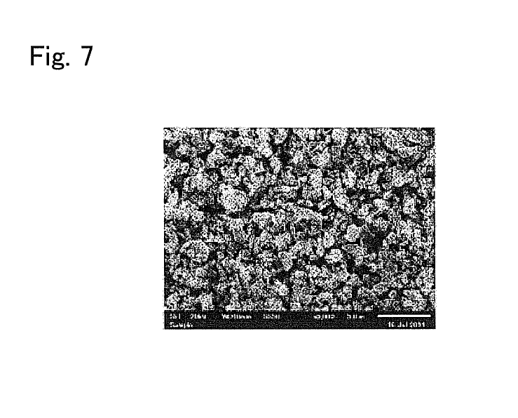

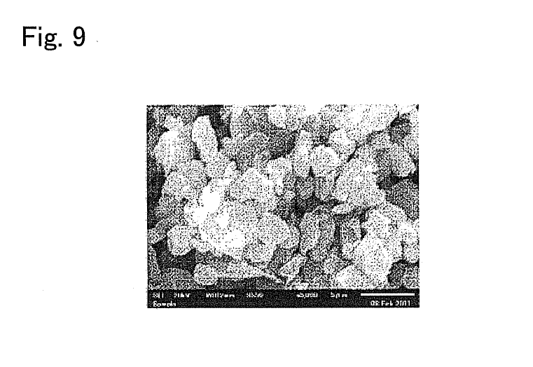

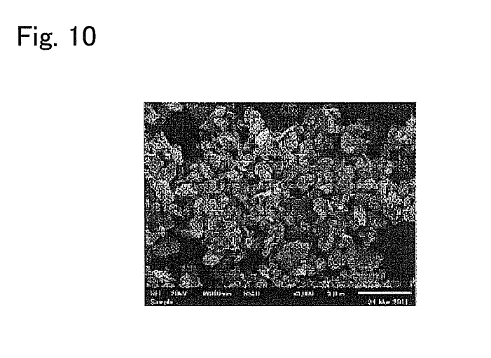

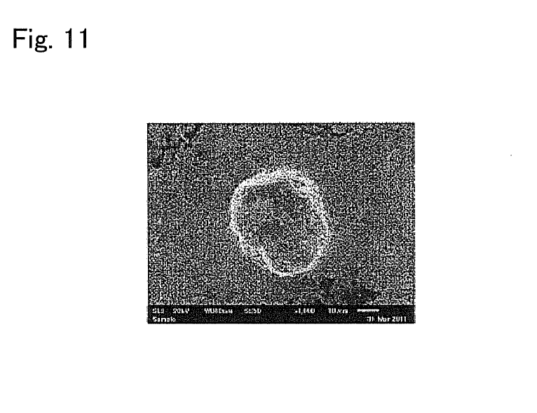

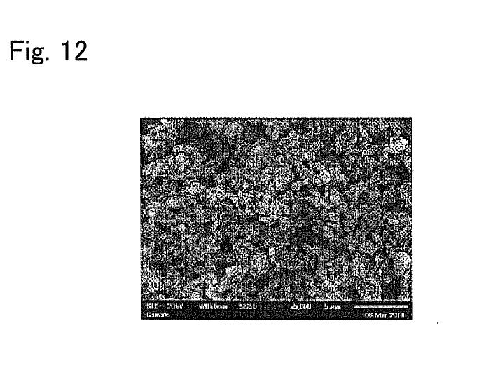

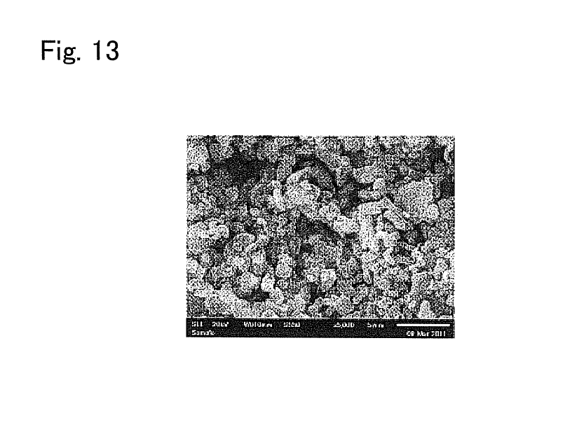

Producing conditions, results of lithium ion conductivity measurement, and results of particle size distribution measurement of the sulfide solid electrolyte of Examples 1 to 4 and Comparative Examples 1 to 5 are shown in Table 1. Here, D10 means a diameter of a particle whose accumulation of cumulative particle size distribution from a side of micro particle is 10%, D50 means a diameter of a particle whose accumulation of cumulative particle size distribution from a side of micro particle is 50%, and D90 means a diameter of a particle whose accumulation of cumulative particle size distribution from a side of micro particle is 90%. Also, relationships between average particle size and lithium ion conductivity of the sulfide solid electrolytes of Examples 1 to 4 and Comparative Examples 1 to 5 are shown in FIG. 3. In FIG. 3, Lithium ion conductivity σ[S/cm] is taken along the vertical axis, and average particle diameter D50 [μm] is taken along the horizontal axis. Photos of the sulfide solid electrolytes of Examples 1 to 4 and Comparative Examples 1 to 5 observed at 5000-fold magnification (FIGS. 4 to 10, 12 and 13) or at 1000-fold magnification (FIG. 11) are shown in FIGS. 4 to 13.

TABLE 1

| | | Numbers of | | Particle Diameter | | | Li ion | |
|---|---|---|---|---|---|---|---|---|
| Diameter of Ball | | Rotation | Grinding | [μm] | | | Conductivity | |
| φ1 mm | φ0.3 mm | [rpm] | Time [h] | D10 | D50 | D90 | σ [S/cm] | |
| 25 wt % | 75 wt % | 150 | 10 | 0.6 | 1.1 | 2.4 | 1.0 × 10⁻³ | Example 1 |
| 25 wt % | 75 wt % | 150 | 20 | 0.5 | 0.9 | 1.9 | 1.0 × 10⁻³ | Example 2 |
| 25 wt % | 75 wt % | 200 | 10 | 0.6 | 1.2 | 2.8 | 1.1 × 10⁻³ | Example 3 |
| 50 wt % | 50 wt % | 150 | 20 | 0.6 | 1.1 | 2.4 | 1.0 × 10⁻³ | Example 4 |
| 100 wt % | 0 wt % | 150 | 10 | 1.5 | 2.5 | 4.9 | 1.2 × 10⁻³ | Comparative Example 1 |
| 100 wt % | 0 wt % | 100 | 10 | 2.5 | 4.2 | 7.5 | 1.2 × 10⁻³ | Comparative Example 2 |
| 0 wt % | 100 wt % | 200 | 10 | 0.8 | 1.6 | 11.2 | 1.0 × 10⁻³ | Comparative Example 3 |
| 0 wt % | 100 wt % | 300 | 10 | 0.6 | 1.7 | 3.7 | 4.1 × 10⁻⁴ | Comparative Example 4 |
| 0 wt % | 100 wt % | 450 | 10 | 1.2 | 2.6 | 4.9 | 4.2 × 10⁻⁴ | Comparative Example 5 |

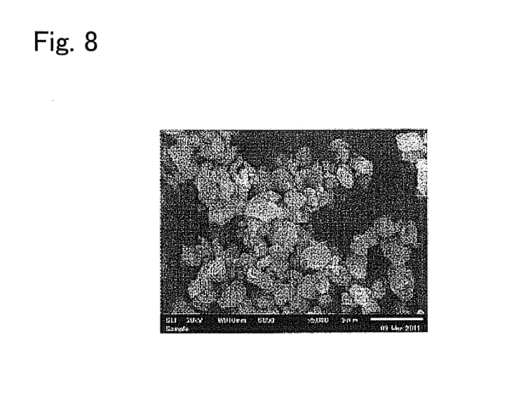

As shown in Table 1, the sulfide solid electrolyte of Examples 1 to 4 each had a lithium ion conductivity of no less than 1.0×10⁻³ S/cm, and had an average particle diameter D50 of no more than 1.2 μm. As shown in FIGS. 4 to 7 as well, the sulfide solid electrolyte of Examples 1 to 4 each had a small average particle diameter. Against this, the sulfide solid electrolyte of Comparative Examples 1 to 5 each had a lithium ion conductivity of 4.1×10⁻⁴ to 1.2×10⁻³, and had an average particle size D50 of no less than 1.6 μm. As shown in FIGS. 8 to 13, the sulfide solid electrolyte of Comparative Examples 1 to 5 each had a larger particle diameter than that of each of the sulfide solid electrolyte of Examples 1 to 4, and as shown in FIG. 11, in Comparative Example 3, large particles that had not been grinded were remained. Also, comparing the sulfide solid electrolytes of Comparative Examples 1 to 5 with that of Examples 1 and 3 that have the same grinding treatment time, the sulfide solid electrolytes of Examples 1 and 3 that employed the present invention each had a smaller particle diameter. Considering the above, according to the present invention, it was possible to improve productivity of a sulfide solid electrolyte having a smaller particle diameter.

### DESCRIPTION OF THE REFERENCE NUMERALS

1. sulfide solid electrolyte
2. solvent
3. first grinding medium
4. second grinding medium

1. A method for producing a sulfide solid electrolyte comprising:
(i) a mixing step of mixing a solvent and one or more selected from a group consisting of a sulfide electrolyte and a raw material of the sulfide solid electrolyte, thereby obtaining a mixture; and
(ii) a grinding step of mechanically grinding the sulfide solid electrolyte using both a first grinding medium having a particle diameter of less than 1 mm and a second grinding medium having a diameter of no less than 1 mm at the same time, wherein an ether compound is mixed into the mixture before the grinding.

2. (canceled)
